(19) United States
(12) Patent Application Publication
(10) Pub. No.: US 2025/0036957 A1
(43) Pub. Date: Jan. 30, 2025

(54) METHOD FOR AUTOMATING A MODEL-BASED DECISION-MAKING WORKFLOW

(71) Applicant: Mombo Technologies, Inc., San Jose, CA (US)

(72) Inventor: Tony Biz, San Jose, CA (US)

(21) Appl. No.: 18/785,882

(22) Filed: Jul. 26, 2024

Related U.S. Application Data
(60) Provisional application No. 63/529,288, filed on Jul. 27, 2023.

(51) Int. Cl. G06N 3/091; G06N 3/045

(52) U.S. Cl. CPC G06N 3/091; G06N 3/045

(57) ABSTRACT

A method for a decision-making workflow includes: receiving a prompt associated with a pending decision; identifying a set of options representing candidates for the pending decision; and identifying a set of factors representing attributes of the set of options. The method further includes, generating a script instructing a generative transformer model to, based on the prompt: access a set of combinations of options and factors based on the set of options and the set of factors; and generate a score, in a set of scores, for each combination in the set of combinations, the score representing suitability of the combination according to pending decision. The method also includes: calculating a composite score, in a set of composite scores, for each option, in the set of options based on the set of scores; and generating a decision matrix including cells containing the set of scores and the set of composite scores.

### CROSS-REFERENCE TO RELATED APPLICATIONS

This application claims the benefit of U.S. Provisional Application No. 63/529,288, filed on 27 Jul. 2023, which is hereby incorporated in its entirety by this reference.

### TECHNICAL FIELD

This invention relates generally to the field of decision-making and more specifically to a new and useful method for automating a model-based decision-making workflow within the field of decision-making.

### BRIEF DESCRIPTION OF THE FIGURES

FIG. 1 is a flowchart representation of a method;

FIG. 2 is a flowchart representation of the method;

FIG. 3 is a flowchart representation of the method;

FIG. 4 is a flowchart representation of the method; and

FIG. 5 is a flowchart representation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

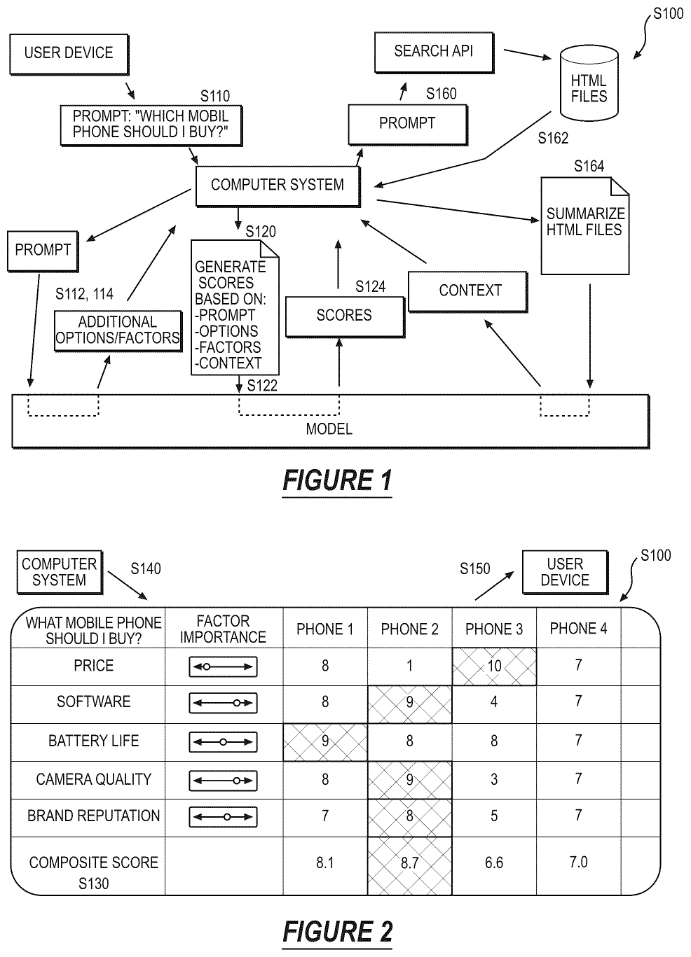

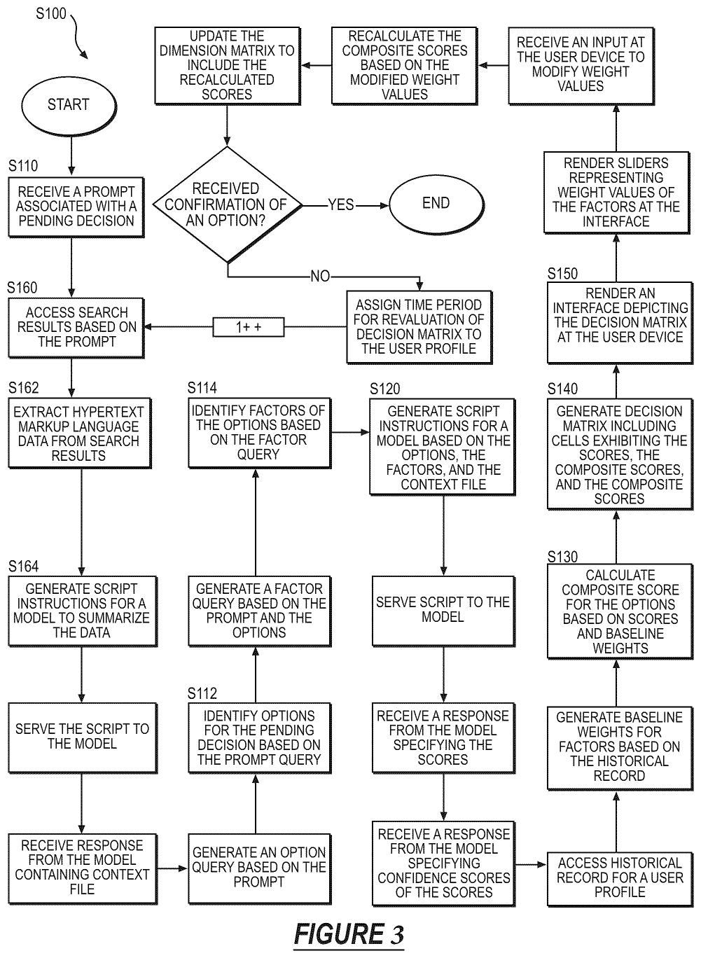

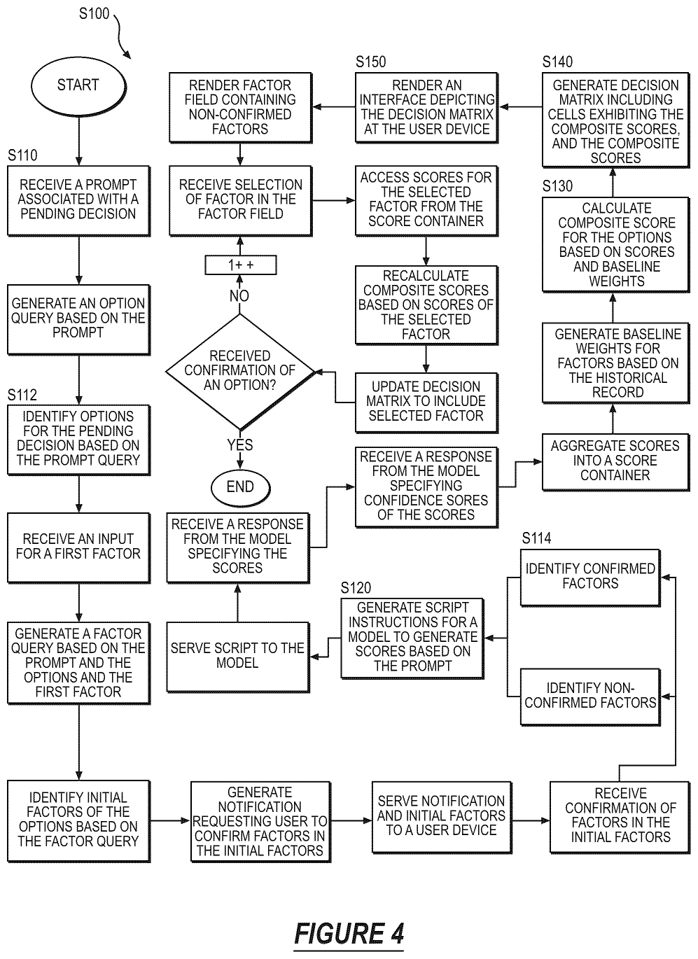

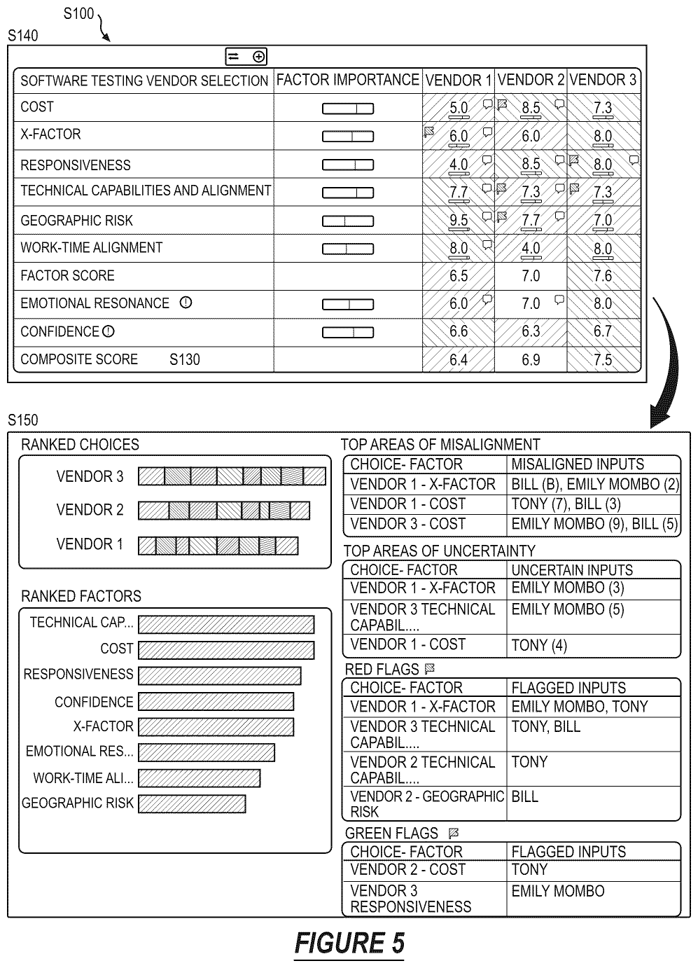

As shown in FIGS. 1 and 2, a method S100 includes: receiving a first prompt associated with a pending decision from a first user device in Block S110; identifying a first set of options representing candidates for the pending decision in Block S112; and identifying a first set of factors representing criteria for the pending decision and attributes of the first set of options in Block S114.

The method S100 also includes, in Block S120, generating a first script instructing a generative pre-trained transformer model to, based on the first prompt: for a first option, in the first set of options, access a first set of combinations of the first option and the first set of factors, and generate a first set of scores corresponding to the first set of combinations and representing suitability of the first option according to the first set of factors; and for a second option, in the first set of options, access a second set of combinations of the second option and the first set of factors, and generate a second set of scores corresponding to the second set of combinations and representing suitability of the second option according to the first set of factors. The method S100 also includes: serving the first script to the generative pre-trained transformer model for execution in Block S122; and receiving, from the generative pre-trained transformer model, a response specifying the first set of scores and the second set of scores in Block S124.

The method S100 further includes, in Block S130, calculating a first set of composite scores including: a first composite score of the first option based on the first set of scores; and a second composite score of the second option based on the second set of scores.

The method S100 also includes, in Block S140, generating a decision matrix including: a first set of cells corresponding to the first set of combinations and exhibiting the first set of scores and the first composite score; and a second set of cells corresponding to the second set of combinations and exhibiting the second set of scores and the second composite score.

The method S100 further includes rendering an interface depicting the decision matrix at the first user device in Block S150.

### 1.1 Variation: Context Data

In one variation, as shown in FIGS. 1 and 2, Blocks of the Method S100 can further include: accessing a first set of search results based on the first prompt in Block S160; extracting a first corpus of hypertext markup language data, representing information related to the first set of options, from the set of search results in Block S162; and generating a second script instructing the generative pre-trained transformer model to summarize the first corpus of hypertext markup language data as a context data (e.g., context file) in Block S164. In this variation, the method S100 further includes: prior to serving the first script to the generative pre-trained transformer model, serving the second script to the generative pre-trained transformer model; and receiving the context data (e.g., context file) from the generative pre-trained transformer model.

In this variation, the method S100 also includes, in Block S130, generating the first script instructing the generative pre-trained transformer model to, based on the first prompt and the context data (e.g., context file): generate the first set of scores corresponding to the first set of combinations and representing suitability of the first option according to the first set of factors; and generate the second set of scores corresponding to the second set of combinations and representing suitability of the second option according to the first set of factors.

### 2. Applications

Generally, Blocks of the method S100 can be executed by a system including a computer system (e.g., computing device) and a model (e.g., large language model, generative pre-trained transformer): to receive user input specifying a prompt representing a decision to be made by a user (e.g., “which mobile phone should I purchase,” “what is the best treatment for pancreatic cancer”), options (e.g., choices) from which to select for the decision, and factors differentiating the options and representing criteria for the decision (e.g., price, accessibility, durability, side effects); to identify additional options and/or additional factors for the decision; to generate scores for each option according to each factor based on the prompt; and to populate a decision matrix with these scores. The system can execute Blocks of the method S100: to calculate composite scores for the options based on these scores; to populate the decision matrix with the composite scores; and to serve an interface depicting the decision matrix at a user device.

Accordingly, Blocks of the method S100 can be executed by the system: to automatically transform a textual prompt-representing the decision to be made by the user-into a decision matrix summarizing an evaluation of a set of options based on a set of factors and the prompt; and to serve an interface depicting the decision matrix at a user device of the user. Therefore, Blocks of the method S100 can be executed by the system: to streamline a decision-making workflow for the user who may exhibit limited knowledge of a field related to the decision to be made, an extensive set of options available for the decision, and/or a comprehensive set of factors to consider for each of these options; and to organize information in a visual layout that aids the user in rapidly understanding differences between these options in context of the user's particular needs in order to complete the decision while obviating manual research required by the user.

### 2.1 Factor Weighting

More specifically, Blocks of the method S100 can be executed by the system: to render sliders on the interface to control weights assigned to factors and representing importance of the factors to the decision; to assign weights to the factors based on positions of the sliders on the interface; and to calculate (or re-calculate) the composite scores based on the weights as updated composite scores.

Accordingly, Blocks of the method S100 can be executed by the system to update the decision matrix depicted on the interface—in real-time (or approximating real-time)-based on the updated composite scores. Therefore, Blocks of the method S100 can be executed by the system to enable a user to customize the decision matrix based on the user's needs and/or preferences.

### 2.2 Automated Decision Updates

Blocks of the method S100 can be executed by the system to: autonomously (e.g., routinely) and/or manually (e.g., receiving request from a user) access search results according to a pending decision, such as from publicly available search result hyperlinks and/or from private data repositories; compile available data (e.g., hypertext markup language data, product specifications, private documents, databases) from these search results into a context data (e.g., context file) representing information related to the pending decision; and periodically (e.g., weekly, monthly) generate new scores for combinations of available options and factors of the pending decision based on relevant information contained in the context data (e.g., context file).

More specifically, the system can: at a first time, access a first set of search results (e.g., search result hyperlinks) according to a decision domain (e.g., cells phones, treatment plans, vendors) of the pending decision; access a corpus of hypertext mark-up language data (or “context data”) corresponding to the first set of search results; and compile the data into a context data representing information related to the pending decision such as, available options for the pending decision, factors for these options, and descriptions for criteria of these options and attributes of these factors. The system can then, generate script instructing the model to, based on the prompt and the context data (e.g., context file): access combinations of available options and selected factors for the pending decision; and generate scores for each of these combinations representing suitability of an option according to a corresponding factor.

The system can then, routinely (e.g., weekly, monthly) repeat the process described above to: periodically generate context data (e.g., context files) representing up-to-date information related to the pending decision; and routinely serve scripts to the model to regenerate scores of combinations of available options and factors based on the up-to-date context data (e.g., context file) related to the pending decision. Accordingly, the system can then: update the decision matrix according to these regenerated scores received from the model; generate a notification informing a user of updated scores; and serve this notification to the user device.

Therefore, the system can: autonomously and routinely generate scores for combinations of available options and factors based on up-to-date information related to a pending decision; and notify a user of updated scores for these combinations and/or significant changes from previous scores in the decision matrix.

### 3. Terminology

Generally, a “prompt” refers to a textual input associated with a pending decision to be made.

Generally, a “script” refers to a textual input representing instructions (or a query) interpreted and/or executed by another program (e.g., large language model, generative pre-trained transformer).

### 4. System

Generally, the system can include: a computer system; a model (e.g., large language model, generative pre-trained transformer); a population of user devices; and a communication network. The computer system can be communicatively coupled to the model and the population of user devices via the communication network (e.g., wired communication network, wireless communication network, the Internet).

In another implementation, the computer system can receive a prompt-representing a decision to be made (or “pending decision”)—from a user device associated with a user. Additionally, the computer system can receive: a set of options representing candidates for the pending decision; and a set of factors representing criteria for the pending decision and representing attributes of the set of options.

In another implementation, in response to receiving the prompt, the set of options, and/or the set of factors from the user device, the computer system can cooperate with the model: to interpret the prompt; to evaluate the set of options based on the prompt and the set of factors; to generate a set of scores representing combinations of options and factors, each score—in the set of scores-representing a combination of one option in the set of options and one factor in the set of factors; to populate a decision matrix with the prompt, the set of options, the set of factors, and the set of scores; and to serve the decision matrix to the user device.

Accordingly, the system can: receive a prompt, from a user device, associated with a pending decision to be made by a user; identify a set of options and a set of factors associated with the pending decision based on the prompt; perform an evaluation of the set of options based on the set of factors and the prompt; and serve an interface-depicting a decision matrix summarizing the evaluation—to the user device. Therefore, the computer system can: streamline a decision-making workflow for a user who may exhibit limited knowledge of a field related to the pending decision to be made, a set of options available for the pending decision, and/or a set of factors to consider for each option in the set of options; and organize information in a visual layout that aids the user in rapidly understanding differences between these options in context of the user's particular needs in order to arrive at a solution (or “completed decision”).

### 5. User Input

Blocks S110, S112, and S114 of the method S100 recite: receiving a first prompt associated with a pending decision from a first user device; identifying a first set of options representing candidates for the pending decision; and identifying a first set of factors representing criteria for the pending decision and attributes of the set of options.

Generally, the system can: receive a prompt (e.g., natural language text string); implement natural language processing techniques to detect a set of natural language signals in the prompt; identify a decision domain (e.g., technology, restaurants, treatment plans) corresponding to the pending decision. The system can then identify options, factors, and context information according to the decision domain of the pending decision; and

In one implementation, the computer system can receive—from a user device associated with a user (e.g., via a user interface)—a prompt associated with a pending decision to be made by the user.

In one example, the computer system receives a first prompt specifying, “Which mobile phone should I buy?”

In another example, the computer receives a second prompt specifying, “What is the best home treadmill to buy in 2023 for under $1500?”

### 5.1 Options

Generally, the computer system can identify a set of options representing candidates for the pending decision.

In one implementation, the computer system can receive a first set of options from the user device. For example, the computer system can receive: a first prompt specifying “Which mobile phone should I buy?”; and a first set of options specifying a first candidate mobile phone and a second candidate mobile phone.

Additionally or alternatively, the computer system can: submit a query to the model for a second set of options based on the prompt; and receive the second set of options from the model based on the query. For example, the computer system can receive the second set of options specifying: the first candidate mobile phone; a third candidate mobile phone; and a fourth candidate mobile phone.

The computer system can identify the set of options based on a combination of the first set of options and the second set of options.

Accordingly, by identifying the set of options based on a combination of the first set of options—received from the user device associated with a user—and the second set of options based on a response from the model, the computer system can thereby ensure that additional options—that may be unknown by the user and/or absent from user input—are evaluated.

### 5.2 Factors

Generally, the computer system can identify a set of factors representing criteria for the pending decision and representing attributes of the set of options.

In one implementation, the computer system can receive a first set of factors from the user device. For example, the computer system can receive: a first prompt specifying “Which mobile phone should I buy?”; and a first set of factors including a first factor representing price and a second factor representing software.

Additionally or alternatively, the computer system can: submit a query to the model for a second set of factors based on the prompt; and receive the second set of factors from the model based on the query. For example, the computer system can receive the second set of factors including: the first factor; the second factor; a third factor representing battery life; and a fourth factor representing camera quality.

The computer system can identify the set of factors based on a combination of the first set of factors and the second set of factors.

Accordingly, by identifying the set of factors based on a combination of the first set of factors—received from the user device associated with the user—and the second set of factors based on a response from the model, the computer system can thereby ensure that additional factors—that may be unknown by the user and/or absent from user input—are evaluated.

### 5.3 Context Information

Additionally, the computer system can receive a description—specifying additional details and/or constraints related to the pending decision—as context information. For example, the computer system can receive: the first prompt specifying, “Which mobile phone should I buy?”; and a first description specifying user possession of a laptop computer exhibiting a particular operating system type and a particular set of input/output interfaces.

### 6. Script

Block S120 of the method S100 recites, generating a first script instructing a generative pre-trained transformer model to, based on the first prompt: for a first option, in the set of options, access a first set of combinations of the first option and the first set of factors, and generate a first set of scores corresponding to the first set of combinations and representing suitability of the first option according to the first set of factors; and for a second option, in the set of options, access a second set of combinations of the second option and the first set of factors, and generate a second set of scores corresponding to the second set of combinations and representing suitability of the second option according to the first set of factors.

Generally, the computer system can generate a script instructing the model to generate scores for combinations of options, in the set of options, and factors in the set of factors.

In one implementation, the computer system can generate the script instructing the model to access a set of combinations of options and factors, each combination in the set of combinations associated with an option—in the set of options—and a factor in the set of factors. More specifically, in this implementation, the system can generate a natural language script representing instructions for the model. For example, the system can generate the natural language script including: a first string of text characterized by a first set of natural language signals representing instructions to generate the first set of scores corresponding to combinations of a first option and a set of factors, and representing suitability of the first option according to the first set of factors; and a second string of text characterized by a second set of natural language signals representing instructions to generate the second set of scores corresponding to combinations of a second option and the set of factors, and representing suitability of the second option according to the first set of factors.

For example, for a set of options including a first mobile phone and a second mobile phone, and for a set of factors including a first factor representing price and a second factor representing software (e.g., operating system), the computer system can generate the script instructing the model to access a set of combinations including: a first combination representing price of the first mobile phone; a second combination representing price of the second mobile phone; a third combination representing software of the first mobile phone; and a fourth combination representing software of the second mobile phone.

In another implementation, the computer system can generate the script further instructing the model to generate a score, in a set of scores, for each combination in the set of combinations based on the prompt and/or the context information (e.g., description).

For example, based on a first prompt specifying “Which mobile phone should I buy?”, the computer system can generate a script instructing the model to generate a set of scores—for a set of combinations of options and factors—including: a first score representing the first combination (e.g., price of the first mobile phone); a second score representing the second combination (e.g., price of the second mobile phone); a third score representing the third combination (e.g., software of the first mobile phone); and a fourth score representing the fourth combination (e.g., software of the second mobile phone).

In one implementation, the computer system can generate the script further instructing the model to generate a response specifying the set of scores. Additionally, the computer system can generate the script further instructing the model to generate the response exhibiting a particular format in a set of formats.

The computer system can serve the script to the model for execution.

### 6.1 Additional Context

Blocks S160, S162, and S164 of the method S100 recite: accessing a first set of search results based on the first prompt; extracting a first corpus of hypertext markup language data, representing information related to the first set of options, from the set of search results; and generating a second script instructing the generative pre-trained transformer model to summarize the first corpus of hypertext markup language data as a context data (e.g., context file).

In one variation, in response to receiving the prompt, the computer system can retrieve a set of search results (e.g., publicly available search result hyperlinks) based on the prompt; access data (e.g., a set of hypertext markup language data) corresponding to the set of search results; compile this data as (additional) context information; and generate the script instructing the model to generate a score, in a set of scores, for each combination in the set of combinations based on the prompt and the context information (e.g., description, data corresponding to the set of search results).

For example, the computer system can: receive a prompt specifying, “Which mobile phone should I buy?”; submit a query—to a search engine (or other data source) via an application programming interface—for a set of search results based on the prompt; and receive a set of search results. In response to receiving the set of search results, the computer system can: access a set of hypertext markup language data corresponding to the set of search results (or a subset of search results); and generate a second query to the model to summarize the set of hypertext markup language data as a context data (e.g., context file). Then, in response to receiving the context data (e.g., context file) from the model, the computer system can generate the script instructing the model to generate a set of scores for combinations of options and factors based on the prompt and the context data (e.g., context file).

In one implementation, the system can: in response to receiving the prompt, access a set of search results associated with the pending decision; access a corpus of hypertext markup language data, representing information (e.g., reviews, specifications, website descriptions) related to a set of options, from the set of search results; and generate an initial script instructing the model to summarize the corpus of hypertext markup language data as a context data (e.g., context file) associated with the set of options. Accordingly, prior to serving a script instructing the model to generate scores as described above, the system can: serve the initial script to the model for execution; receive the context data (e.g., context file) associated with the set of options from the model; and, following receipt of the context data (e.g., context file), serve the script instructing the model to generate scores. Thus, as described below, the system can then receive scores for combinations of options and factors from the model based on the prompt associated with the pending decision in addition to the context data (e.g., context file) representing information related to the set of options.

Accordingly, the computer system can: access current information related to the prompt based on the search results; consolidate this information into key elements within the context data (e.g., context file); and generate the script instructing the model to generate scores based on the prompt and the context data (e.g., context file). Therefore, the computer system can: supplement the model—which may be trained based on a training data set during a first period (e.g., September 2021)—with additional and current context information from a second period succeeding the first period, thereby ensuring the scores are generated based on latest available options and/or latest information.

### 7. Model

Blocks S122 and S124 of the method S100 recite: serving the first script to the generative pre-trained transformer model for execution; and receiving, from the generative pre-trained transformer model, a response specifying the first set of scores and the second set of scores.

Generally, the model can implement natural language processing techniques to: interpret a received input from a device; generate an output responsive to the received input; and serve the output to the device. The model can be trained based on a corpus of training data correlating a population of problems—across a population of subject areas—with a population of solutions to the problems. The model can be trained based on other training data and/or additional information.

In one implementation, in response to receiving the script from the computer system, the model can: interpret the prompt, the set of options, the set of factors, and/or the context information based on the script; generate the set of scores—for combinations of options in the set of options and factors in the set of factors—based on the prompt and/or the context information; and return a response, to the computer system, specifying the set of scores. In this implementation, the model can generate a score exhibiting an integer value between 0 and 10. Alternatively, the model can generate a score exhibiting a decimal value within another range of values. More specifically, the model can generate the score representing a relative value to a user (e.g., a score of “zero” representing lowest value, a score of “10” representing highest value).

For example, based on the first prompt specifying “Which mobile phone should I buy?” and a first combination representing price of the first mobile phone, the model can generate a first score of “8,” in the set of scores, associated with the first combination. The model can repeat this process to generate each score in the set of scores.

In another implementation, the model can generate a response specifying the set of scores and exhibiting a particular format in a set of formats based on the script.

Additionally, the model can generate the response further specifying: a first set of descriptions characterizing the set of options; a first set of hyperlinks associated with the set of options; a second set of descriptions characterizing the set of factors; a second set of hyperlinks associated with the set of factors; a third set of descriptions, each description in the third set of descriptions characterizing a reasoning for assigning a score (value) in the set of scores; a set of confidence scores for the set of scores, each confidence score in the set of confidence scores representing a level of certainty of a score in the set of scores; and/or other information related to the prompt, the set of options, or the set of factors, etc.

The model can return the response to the computer system.

### 8. Scores

Block S130 of the method S100 recites, calculating a first set of composite scores including: a first composite score of the first option based on the first set of scores; and a second composite score of the second option based on the second set of scores. Generally, the system can calculate a composite score for each option, in a set of options, associated with a pending decision of a prompt and representing an evaluation of the option according to the set of factors.

In one implementation, the computer system can: receive the response—specifying the set of scores and exhibiting the particular format—from the model; and extract the set of scores from the response.

In another implementation, the computer system can calculate a set of composite scores for the set of options based on the set of scores. More specifically, for each option in the set of options, the computer system can calculate a composite score based on (e.g., a sum of) a subset of scores—in the set of scores—associated with the option.

### 8.1 Confidence & Flags

In one implementation, the computer system can assign a confidence score (e.g., an integer value between 0 and 10)—to a score in the set of scores—representing a level of certainty of the score. In one example, the computer system assigns the confidence score to the score based on the response from the model. In another example, the computer system assigns the confidence score to the score based on a user input.

Additionally or alternatively, the computer system can assign a flag (e.g., green flag, red flag)—representing favorability (e.g., very favorable, very unfavorable) to a combination representing an option in the set of options and a factor in the set of factors. In one example, based on a first user input, the computer system assigns a green flag to a first combination representing price of a first mobile phone, indicating the user characterizing the price of the first mobile phone as very favorable. In one example, based on a second user input, the computer system assigns a red flag to a second combination representing price of a second mobile phone, indicating the user characterizing a price of the second mobile phone as very unfavorable.

In another implementation, the computer system can calculate the set of composite scores for the set of options based on the set of scores, the set of confidence scores, and/or flags assigned to combinations of options and factors.

In one implementation, the system can: access a context data (e.g., context file), as described above, representing information related to the set of options; and generate a script instructing the model to generate scores for combinations of options and factors based on the context data (e.g., context file). For example, the context data (e.g., context file) can include: a first specification related to information for a first option corresponding to a first mobile phone; and a second specification related to information for a second option corresponding to a second mobile phone. In this example, the first specification can represent a string of text describing battery features, software features, and camera features of the first mobile phone. The second specification can represent a string of text describing battery features and software features of the second mobile phone. Accordingly, since camera features of the second mobile phone are absent from the second specification, the model can return a low confidence score (e.g., “3”) for a generated suitability score (e.g., “5”) corresponding to a combination of the second mobile phone option and a camera factor.

In one implementation, the system can: access a context data (e.g., context file) representing information related to a set of options; and, based on the prompt and the context data (e.g., context file), generate a script instructing the model to: for a first option, in the set of options, generate a first set of confidence scores corresponding to a first set of scores and representing a degree of certainty of each score; and for a second option, in the set of options, generate a second set of confidence scores corresponding to the second set of scores and representing a degree of certainty of each score. The system can then, following serving the script to the model for execution, receive from the model: a first set of scores representing suitability of a first set of combinations of the first option and a set of factors; a first set of confidence scores representing a degree of certainty of the first set of scores; a second set of scores representing suitability of a second set of combinations of the second option and the set of factors; and a second set of confidence scores representing a degree of certainty of the second set of scores.

Thus, as described below, the system can generate a decision matrix including: a first set of cells corresponding to the first set of combinations and exhibiting the first set of scores, the first composite score, and the first set of confidence scores; and a second set of cells corresponding to the second set of combinations and exhibiting the second set of scores, the second composite score, and the second set of confidence scores.

Furthermore, the system can access a confidence score threshold associated with the first set of factors and, in response to a first confidence score—in the first set of confidence scores—falling below the confidence score threshold: flag a first option-factor combination associated with the first confidence score and a first score; and generate a notification requesting additional context from the user related to the first option-factor combination of the pending decision. The system can then: serve the notification to the first user device; and receive a context data (e.g., context file)—such as previously-generated based on search results of the options as described above, or uploaded by the user at the user device—representing additional information of the first combination (e.g., text description). Accordingly, the system can then generate a second script instructing the model to, based on the prompt and the context data (e.g., context file): regenerate the score for the option-factor combination; and regenerate the confidence score associated with the score. The system can then: serve the script to the model; receive the regenerated score and the regenerated confidence score from the model; and update the decision matrix by inserting the regenerated score and confidence score into a cell corresponding to the option-factor combination.

Therefore, the system can: generate confidence scores representing degrees of certainty of generated option-factor combinations, and regenerate scores based on additional context received for these option-factor combinations.

### 9. Decision Matrix

Block S140 of the method S100 recites, generating a decision matrix including: a first set of cells corresponding to the first set of combinations and exhibiting the first set of scores and the first composite score; and a second set of cells corresponding to the second set of combinations and exhibiting the second set of scores and the second composite score. Generally, the system can: generate a visual matrix representation of combinations of available options and factors for a pending decision; and populate the visual matrix representation with previously-generated scores and composite scores corresponding to these combinations.

In one implementation, the computer system can generate a decision matrix including a set of cells including: a first subset of cells representing the set of combinations of options and factors; and a second subset of cells representing a set of composite scores for the set of options.

In one example, the computer system generates the decision matrix including: a first set of columns corresponding to the set of options; and a first set of rows corresponding to the set of factors, the first subset of cells—representing the set of combinations of options and factors—occupying the first set of columns and the first set of rows. In this example, the computer system generates the decision matrix further including an additional row including the second subset of cells indicating the set of composite scores for the set of options.

In another example, the computer system generates the decision matrix including: a first set of columns corresponding to the set of factors; and a first set of rows corresponding to the set of options, the first subset of cells—representing the set of combinations of options and factors—occupying the first set of columns and the first set of rows. In this example, the computer system generates the decision matrix further including an additional column including the second subset of cells representing the set of composite scores for the set of options.

In another implementation, the computer system can: populate the first subset of cells with the set of scores; and populate the second subset of cells with the set of composite scores.

### 9.1 Superlatives

Generally, for each factor in the set of factors, the computer system can identify a superlative option—in the set of options—exhibiting a highest score associated with the factor. The computer system can generate the decision matrix indicating (e.g., coloring, highlighting, sorting) the superlative option.

In one implementation, the computer system can identify a first option—in the set of options—exhibiting a highest score for a first factor in the set of factors; and assign a first color (e.g., green) to a first cell representing a combination of the first factor and the first option.

Additionally, the computer system can identify a second option—in the set of options—exhibiting a lowest score for the first factor; and assign a second color (e.g., red) to a second cell representing a combination of the first factor and the second option.

The computer system can assign other colors to cells—representing combinations of the first factor and other options in the set of options—based on scores within these cells.

The computer system can repeat this process for each factor in the set of factors. The computer system can sort the set of options within the decision matrix based on composite score. For example, the computer system can sort the set of options within the decision matrix from an option exhibiting highest composite score to an option exhibiting lowest composite score.

In another implementation, the computer system can implement methods and techniques described above to: identify a third option, in the set of options, exhibiting a highest composite score in the set of composite scores; assign the first color to a third cell representing a composite score of the third option; identify a fourth option, in the set of options, exhibiting a lowest composite score in the set of composite scores; and assign the second color to a fourth cell representing a composite score of the fourth option.

### 9.2 User Interface

Block S150 of the method S100 recites, rendering an interface depicting the decision matrix at the first user device. Generally, the system can generate the interface such as, at a user portal on a user device, to: present decision matrix such as, at an integrated display at the user device, to the user; and enable the user to interact with the decision matrix to add/remove options and features, submit additional context for relevant options, flag combinations of options and features, modify scores and confidence scores of these combinations.

In one implementation, the computer system can: generate an interface depicting the decision matrix; and serve the interface to the user device.

Additionally, based on the response from the model, the computer system can generate the interface specifying: the prompt; the first set of descriptions characterizing the set of options; the first set of hyperlinks associated with the set of options; the second set of descriptions characterizing the set of factors; the second set of hyperlinks associated with the set of factors; the third set of descriptions characterizing reasoning for assigning scores in the set of scores; the set of confidence scores representing levels of certainty of scores in the set of scores; and/or other information related to the prompt, the set of options, or the set of factors.

Accordingly, by automatically consolidating descriptions characterizing options and factors into the interface, the computer system can enable the user to: rapidly understand the options and factors; and gain context for the set of scores and/or the set of composite scores. Therefore, the system can obviate manual research required by the user, organize a decision information space, and streamline a decision-making workflow for the user.

### 9.2.1 Add/Remove Factor or Option

In one implementation, the computer system can generate the interface depicting controls to add and/or remove: a factor in the set of factors; and an option in the set of options.

In one example, the computer system generates an interface depicting the decision matrix representing a first subset of options (e.g., options received from the user device) and a first subset of factors (e.g., factors received from the user device). In this example, the computer system generates the interface depicting controls to: add options (e.g., a second subset of options received from the model) to the decision matrix; add factors (e.g., a second subset of factors received from the model) to the decision matrix; remove options from the decision matrix; and/or remove factors from the decision matrix.

In response to receiving input to add (or remove) an option and/or factor, the computer system can recalculate the set of scores and/or the set of composite scores; update the decision matrix; and serve the interface depicting the decision matrix to the user device.

### 9.2.1.1 Example: Adding Option

In one example, the system can: detect a set of language signals—representing a decision domain of a pending decision—in the first prompt; generate a query to retrieve an initial set of options based on the set of language signals, such as from publicly-available information corresponding to the decision domain, and or private data repositories accessible by the system corresponding to the decision domain; and identify the initial set of options based on the query. The system can then: generate a notification requesting a user to confirm options in the initial set of options; serve the notification and the initial set of options to the user device; and receive confirmation of a subset of options, in the initial set of options, at the user device. Accordingly, in response to receiving confirmation of options at the user device, the system can identify the confirmed subset of options as the first set of factors for the pending decision.

Additionally, following calculation of composite scores for available options, the system can: identify a second subset of options, in the initial set of options, exclusive of the first subset of options selected by the user; access a composite score threshold (e.g., “4”) associated with the pending decision; and, in response to a first composite score associated with a first option falling below the composite score threshold, generate a second notification requesting the user to select an alternative option from the second subset of options. The system can then: serve the second notification and the second subset of options to the user device; and receive selection of the alternative option, in the second subset of options, at the user device. Accordingly, in response to receiving selection of the alternative option, the system can generate a script instructing the model to, based on the prompt: access a set of option-factor combinations of the alternative option and the set of factors; and generate a set of scores corresponding to the set of option-factor combinations and representing suitability of the alternative option according to the set of factors.

The system can then: serve the script to the model; receive a response specifying the set of scores corresponding to the set of option-factor combinations from the model; calculate a composite score of the alternative option based on the set of scores; and update the decision matrix to include an additional set of cells exhibiting the set of scores and the composite score of the alternative option.

### 9.2.1.2 Examples: Adding Factor+Pre-Generated Scores

In one example, the system can: detect a set of language signals—representing a decision domain (e.g., mobile devices) of the pending decision (e.g., “Which phone should I buy?”)—in the prompt; receive a second prompt (e.g., text input) specifying a first factor (e.g., battery life) and a second factor (e.g., camera quality) associated with the pending decision; and generate a query to retrieve an initial set of factors for options of the pending decision based on the first factor, the second factor, and the set of language signals. The system can then: identify the initial set of factors (e.g., battery life, camera quality, software ease-of-use, durability, touchscreen quality) based on the first query; generate a notification requesting a user to confirm factors in the initial set of factors; and serve the notification and the initial set of factors to the user device. Furthermore, the system can then: receive confirmation of a subset of factors, in the initial set of factors, at the user device; and, in response to receiving confirmation of the subset of factors, identify the subset of factors confirmed by the user as the set of factors.

In another example, the system can also identify a second set of factors, exclusive of the first set of factors confirmed by the user, representing criteria for the pending decision and attributes of the set of options. The system can then, generate a script instructing the model to, based on the prompt: access option-factor combinations of available options and the second set of factors not confirmed by the user; and generate a set of scores corresponding to these option-factor combinations and representing suitability of the available options according to the second set of factors not confirmed by the user.

The system can then: serve the script to the model; and receive the set of scores corresponding to the option-factor combinations not confirmed by the user. Thus, the system can then: initialize a score container; link the score container to the second set of factors not confirmed by the user; aggregate the set of scores into the score container; and render the interface depicting the decision matrix and a factor selection field including the second set of factors. The system can then: receive selection of a factor of interest, in the second set of factors, at the factor selection field depicted in the interface; and, in response to receiving selection of the factor of interest, aggregate the factor of interest to the first set of factors confirmed by the user.

Accordingly, the system can: based on the score container, aggregate scores—corresponding to combinations of available options and the factor of interest selected by the user—to the previously-generated scores of confirmed option-factor combinations; and recalculate a set of composite scores for each available option based on the aggregated scores. The system can then update the decision matrix to: aggregate new cells corresponding to combinations of the available options and the confirmed feature of interest, which exhibit the aggregated scores; and update previous composite scores with the recalculated composite scores for each available option.

Therefore, rather than generating a new script to generate scores for additional confirmed factors of available options, the system can: generate a container score containing scores for non-confirmed factors of the available options; and, responsive to confirmation of additional factors of interest, update the decision matrix according to scores contained in the score container corresponding to the additional factors of interest.

### 9.2.2 Factor Weights

Generally, the computer system can generate the interface depicting controls to define a set of weights assigned to the set of factors, each weight representing an importance of a factor in the set of factors and applied linearly (or exponentially) to a score.

In one implementation, the computer system can generate the interface depicting a set of sliders, each slider—in the set of sliders—representing a weight assigned to a factor in the set of factors. In response to accessing positions of the set of sliders, the computer system can: assign a set of weights to the set of factors based on the positions of the set of sliders; recalculate the set of composite scores based on the set of weights (e.g., applied linearly, applied exponentially) as a set of updated composite scores; update the interface depicting the decision matrix specifying the updated composite scores; and serve the interface to the user device.

In one example, in response to detecting a first slider—representing a price factor—exhibiting an upper-most position indicating highest importance, the computer system assigns a first weight, in a set of weights, of 1.5 to the price factor. Additionally, in response to detecting a second slider—representing a durability factor—exhibiting a lower-most position indicating lowest importance, the computer system assigns a second weight, in the set of weights, of 0.1 to the durability factor.

In this example, the computer system calculates a first composite score for a first option based on a first subset of scores—associated with the first option—and the set of weights. The computer system: repeats this process for each composite score in the set of composite scores; updates the interface depicting the decision matrix specifying the set of composite scores; and serves the interface to the user device.

Accordingly, by rendering an interface depicting controls for defining the set of weights assigned to the set of factors, the computer system can enable a user to customize the decision matrix in real-time (or approximating real-time) to indicate a particular option best-suited for the user based on the user's needs and/or preferences.

### 10. User Profile

In one implementation, the computer system can: generate a user profile associated with a user; compile the prompt, the set of options, the set of factors, the context information, the set of weights, the script, and/or the decision matrix into a first data container associated with a first decision (e.g., pending decision); and store the first data container in the user profile in a data repository.

In another implementation, the computer system can: receive selection—from the user device—of a particular option in the set of options as a selected option for the first decision; and mark the first decision as a completed decision. Additionally, the computer system can also receive information related to the first decision from the user device, such as comments and/or reasons for selecting the particular option as the selected option, manually entered scores, confidence scores, flags, etc. The computer system can store the selected option and/or the information related to the first decision into the first data container in the user profile.

The computer system can store a set of data containers associated with a set of decisions (e.g., pending decisions, completed decisions) in the user profile.

### 10.1 Historical Context & Weighting

In one implementation, the computer system can: access a user profile associated with a user; extract information associated with a prior decision (e.g., pending decision, completed decision); and, for a future prompt associated with a future decision, generate a script specifying the information associated with the prior decision as context information.

In one example, the computer system: receives a prompt, from a first user device associated with a first user, specifying “What mobile phone should I buy?” as a first pending decision; accesses a first user profile associated with the first user; extracts a selected option (e.g., a first laptop computer option)—from a second data container within the user profile and associated with a second completed decision—as context information; and generates a script instructing the model to generate a set of scores based on the prompt and the context information (i.e., the first laptop computer option as the selected option).

In another example, the computer system: accesses a first weight of “10” associated with a first price factor from the second data container associated with the second completed decision; and automatically sets a second weight to “10” for a second price factor associated with the first pending decision based on the first weight. More specifically, the computer system generates an interface for the first pending decision depicting a slider occupying an upper-most slider position corresponding to the second weight.

In another example, the system can: access a historical record—representing previously pending and completed decisions by the user profile—of a user profile logged on the user device; and assign a set of baseline weight values to the set of factors based on the historical record. More specifically, the system can: access a historical record of previously pending and/or completed decisions corresponding to a decision domain (e.g., mobile devices) of a currently-pending decision (e.g., “Which phone should I buy?”); identify previously-confirmed factors in the historical record matching the set of factors for the currently-pending decision; extract previously-confirmed weight values from these previously-confirmed factors; and set baseline weight values for the set of factors of the currently-pending decision according to the previously-confirmed weight values.

Additionally, as described above, the system can then calculate composite scores for available options based on the generated set of scores for the option-factor combinations of the currently-pending decision and the baseline weight values.

The system can then render the interface including the set of sliders corresponding to the set of factors. Each slider, in the set of sliders, represent a set baseline weight value of each factor, in the set of factors, of the currently-pending decision. Furthermore, the system can: receive an input to a slider, in the set of sliders, modifying (e.g., increasing, decreasing) a baseline weight value of a factor for a currently-pending decision to a first weight value; and, in response to receiving the input, recalculate the set of composite scores corresponding to the available options of the pending decision according to the input. Thus, the system can then update the decision matrix to replace the set of composite scores of the available options with the recalculated composite scores.

### 11. Decision Update

In one implementation, the computer system can periodically (e.g., daily, weekly, monthly) update a decision matrix for a decision (e.g., pending decision, completed decision) based on updated context information.

In this implementation, the computer system can autonomously: access a user profile associated with a user and storing a prompt associated with the decision; retrieve an updated set of search results based on the prompt; compile data associated with the updated set of search results as updated context information; generate a new script based on the updated context information; and serve the script to the model. The computer system can then: generate an updated decision matrix based on a response from the model; and, in response to a significant change between the updated decision matrix and a prior decision matrix (e.g., a different option exhibiting a highest composite score), transmit a notification to the user device indicating the significant change.

For example, the system can: at a first time, access a first set of search results (e.g., publicly available search results for cell phones) based on the prompt (e.g., “which cell phone should I buy?”); and, as described above, generate a first context data (e.g., context file) representing retrieved information related to the set of options at the first time. As described above, the system can then generate a first script instructing the model to, based on the prompt and the first context data (e.g., context file): access combinations of available options and a set of factors for the pending decision; and generate a first set of scores corresponding to these combinations and representing suitability of the available options according to the set of factors for the pending decision. The system can then, in response to absence of confirmation of an option of interest in the available options, assign a second time, following the first time (e.g., a week from the first time, a month from the first time), for revision of the decision matrix a user profile logged on the user device.

Accordingly, at the second time, the system can: access a second set of search results (e.g., publicly available search results for cells phones) based on the prompt (e.g., “which cell phone should I buy?”); and generate a second context data (e.g., context file), distinct from the first context data (e.g., context file), representing retrieved information related to the set of options at the second time. The system can then generate a second script instructing the model to, based on the prompt and the second context data (e.g., context file): access the combinations of available options and the set of factors for the pending decision; and generate a second set of scores, different from the first set of scores, corresponding to the combinations.

Furthermore, in response to the second set of scores exceeding a threshold deviation (e.g., greater than 5% deviation) from the first set of scores, the system can update the decision matrix to: insert the second set of scores, in place of the first scores, in cells corresponding to the combinations of available options and the set of factors; generate a notification informing a user of updated scores of available option-factor combinations; and serve the notification to the user device.

### 12. Multi-User Workflow

In one implementation, the system can assign access a decision matrix of a pending decision to a first user profile associated with a first user and a second user profile associated with a second user. In this implementation, the system can implement Blocks of the method S100 as described above to generate (i.e., by the generative model) scores, confidence scores, weights, for combinations of options and factors for a pending decision. Additionally, the system can receive inputs—different from inputs for the generative model—to the decision matrix from the first user profile and the second user profile such as: receive addition and/or removal of available options and factors; receive modification of sliders to modify weight values of corresponding factors; receive flags for combinations of options and factors; receive modification to scores and confidence scores represented in the decision matrix; and receive context information (e.g., context data (e.g., context file)) associated with the available options. Accordingly, the system can then, as described above: autonomously update the decision matrix based on these received inputs; and render an interface depicting the updated decision matrix to each of the first user profile and the second user profile. Accordingly, the system can grant access of the decision matrix to any number (e.g., n-number) of users to receive the inputs described above to modify and/or update the decision matrix.

For example, the system can: at a first time, render a first instance of the decision matrix at a first user portal; receive an input representing an alternative score corresponding to a first score of a first cell, in a set of cells, of the decision matrix; in response to receiving the input, insert the alternative score, in place of the first score in the first cell; and recalculate a composite score of a first option associated with the first cell based on previously-generated scores and the alternative score. The system can then, at a second time following the first time, render a second instance of the decision matrix at a second user portal according to the inputs received from the first user portal. In particular, the second instance of the decision matrix can include updated cells corresponding to the first option exhibiting the alternative score input by the first user and the recalculated composite score of the first option.

Therefore, the system can enable a multi-user collaborative workflow environment for a pending decision involving multiple parties.

### 13. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for an automated decision-making workflow comprising:
receiving a first prompt associated with a pending decision from a first user device;
identifying a first set of options representing candidates for the pending decision;
identifying a first set of factors representing criteria for the pending decision and attributes of the set of options;
generating a first script instructing a generative pre-trained transformer model to, based on the first prompt:
for a first option, in the set of options:
access a first set of combinations of the first option and the first set of factors; and
generate a first set of scores corresponding to the first set of combinations and representing suitability of the first option according to the first set of factors; and
for a second option, in the set of options:
access a second set of combinations of the second option and the first set of factors; and
generate a second set of scores corresponding to the second set of combinations and representing suitability of the second option according to the first set of factors;
serving the first script to the generative pre-trained transformer model for execution;
receiving, from the generative pre-trained transformer model, a response specifying the first set of scores and the second set of scores;
calculating a first set of composite scores comprising:
a first composite score of the first option based on the first set of scores; and
a second composite score of the second option based on the second set of scores;
generating a decision matrix comprising:
a first set of cells corresponding to the first set of combinations and exhibiting the first set of scores and the first composite score; and
a second set of cells corresponding to the second set of combinations and exhibiting the second set of scores and the second composite score; and
rendering an interface depicting the decision matrix.

2. The method of claim 1, wherein generating the first script comprises generating a natural language script comprising:
a first string of text comprising a first set of natural language signals representing instructions to:
generate the first set of scores corresponding to the first set of combinations and representing suitability of the first option according to the first set of factors; and
a second string of text comprising a second set of natural language signals representing instructions to:
generate the second set of scores corresponding to the second set of combinations and representing suitability of the second option according to the first set of factors.

3. The method of claim 1:
further comprising:
accessing a first set of search results based on the first prompt;
extracting a first corpus of hypertext markup language data, representing information related to the first set of options, from the set of search results;
generating a second script instructing the generative pre-trained transformer model to summarize the first corpus of hypertext markup language data as a context file;
prior to serving the first script to the generative pre-trained transformer model, serving the second script to the generative pre-trained transformer model; and
receiving the context file from the generative pre-trained transformer model; and
wherein generating the first script comprises generating the first script instructing the generative pre-trained transformer model to, based on the first prompt and the context file:
generate the first set of scores corresponding to the first set of combinations and representing suitability of the first option according to the first set of factors; and
generate the second set of scores corresponding to the second set of combinations and representing suitability of the second option according to the first set of factors.

4. The method of claim 1:
further comprising:
accessing a historical record of a user profile logged onto the first user device, the historical record representing previously pending and completed decisions by the user profile; and
assigning a set of baseline weight values to the first set of factors based on the historical record;
wherein calculating the first composite score and the second composite score comprises, prior to rendering the interface, calculating:
the first composite score of the first option based on the first set of scores and the set of baseline weight values; and
the second composite score of the second option based on the second set of scores and the set of baseline weight values; and
wherein rendering the interface comprises rendering the interface comprising a set of sliders corresponding to the first set of factors, each slider, in the set of sliders representing a baseline weight value of each factor, in the first set of factors.

5. The method of claim 4, further comprising, following rendering of the interface:
receiving a first input to a first slider, in the set of sliders, modifying a first baseline weight value of a first factor, in the first set of factors, to a first weight value;
in response to receiving the first input, calculating a second set of composite scores comprising:
a third composite score of the first option based on the first set of scores and the first input; and
a fourth composite score of the second option based on the second set of scores and the first input; and
updating the decision matrix to:
insert the third composite score, in place of the first composite score, in the first set of cells; and
insert the fourth composite score, in place of the second composite score, in the second set of cells.

6. The method of claim 1, wherein identifying the first set of options comprises:
detecting a first set of language signals in the first prompt, the first set of language signals representing a decision domain of the pending decision;
generating a first query to retrieve an initial set of options based on the first set of language signals;
identifying the initial set of options based on the first query;
generating a first notification requesting a user to confirm options in the initial set of options;
serving the first notification and the initial set of options to the first user device;
receiving confirmation of a first subset of options, in the initial set of options, at the first user device; and
in response to receiving confirmation of the first subset of options, identifying the first subset of options as the first set of options.

7. The method of claim 6, further comprising:
identifying a second subset of options, in the initial set of options, exclusive of the first subset of options selected by the user;
accessing a composite score threshold associated with the pending decision;
in response to a first composite score associated with the first option falling below the composite score threshold, generating a second notification requesting the user to select an alternative option from the second subset of options;
serving the second notification and the second subset of options to the first user device;
receiving selection of the alternative option, in the second subset of options, at the first user device; and
in response to receiving selection of the alternative option:
generating a second script instructing the generative pre-trained transformer model to, based on the first prompt:
access a third set of combinations of the alternative option and the first set of factors; and
generate a third set of scores corresponding to the third set of combinations and representing suitability of the alternative option according to the first set of factors;
serving the second script to the generative pre-trained transformer model for execution;
receiving, from the generative pre-trained transformer model, a second response specifying the third set of scores of the third set of combinations of the alternative option and the first set of factors;
calculating a third composite score of the alternative option based on the third set of scores; and
updating the decision matrix to comprise a third set of cells exhibiting the third set of scores and the third composite score.

8. The method of claim 1, wherein identifying the first set of factors comprises:
detecting a first set of language signals in the first prompt, the first set of language signals representing a decision domain of the pending decision;
receiving a second prompt specifying a first factor and a second factor associated with the pending decision;
generating a first query to retrieve an initial set of factors based on the first set of language signals, the first factor, and the second factor;
identifying the initial set of factors based on the first query;
generating a notification requesting a user to confirm factors in the initial set of factors;
serving the notification and the initial set of factors to the first user device;
receiving confirmation of a first subset of factors, in the initial set of factors, at the first user device; and
in response to receiving confirmation of the first subset of factors, identifying the first subset of factors as the first set of factors.

9. The method of claim 1:
further comprising identifying a second set of factors, exclusive of the first set of factors, and representing criteria for the pending decision and attributes of the first set of options;
wherein generating the first script further comprises generating the first script instructing the generative pre-trained transformer model to, based on the first prompt:
for the first option, in the set of options:
access a third set of combinations of the first option and the second set of factors; and
generate a third set of scores corresponding to the third set of combinations and representing suitability of the first option according to the second set of factors; and
for the second option, in the set of options:
access a fourth set of combinations of the second option and the second set of factors; and
generate a fourth set of scores corresponding to the fourth set of combinations and representing suitability of the second option according to the second set of factors;
wherein receiving the response from the generative pre-trained transformer model comprises receiving the response further specifying:
the third set of scores of the third set of combinations of the first option and the second set of factors; and
the fourth set of scores of the fourth set of combinations of the second option and the second set of factors;
further comprising:
linking the second set of factors to a score container; and
aggregating, the third set of scores and the fourth set of scores into the score container; and
wherein rendering the interface comprises rendering the interface depicting:
the decision matrix; and
a factor selection field comprising the second set of factors.

10. The method of claim 9, further comprising, following rendering of the interface:
receiving selection of a factor of interest, in the second set of factors, at the factor selection field depicted in the interface;
in response to receiving selection of the factor of interest:
aggregating the factor of interest to the first set of factors;
based on the score container:
aggregating a first score, in the third set of scores, corresponding to a first combination of the factor of interest and the first option, to the first set of scores; and
aggregating a second score, in the fourth set of scores, corresponding to a second combination of the factor of interest and the second option, to the second set of scores;
calculating a second set of composite scores comprising:
a third composite score based on the first set of scores comprising the first score; and
a fourth composite score based on the second set of scores comprising the second score;
updating the decision matrix to:
aggregate a first cell, to the first set of cells, corresponding to the first combination of the factor of interest and the first option and exhibiting the first score; and
aggregate a second cell, to the second set of cells, corresponding to the second combination of the factor of interest and the second option and exhibiting the second score;
inserting the first composite score, in place of the first composite score, in the first set of cells; and
inserting the fourth composite score, in place of the second composite score, in the second set of cells.

11. The method of claim 1:
further comprising assigning access of the decision matrix to a first user portal and a second user portal;
wherein rendering the interface comprises rendering the interface depicting a first instance of the decision matrix at the first user portal accessed on the first user device;
further comprising:
at a first time, following rendering of the first instance of the decision matrix at the first user portal:
receiving a first input representing an alternative score for a first score in a first cell, in the first set of cells;
in response to receiving the first input, inserting the alternative score, in place of the first score, in the first cell; and
calculating a third composite score of the first option based on the alternative score and the first set of scores; and
at a second time following the first time, rendering a second instance of the decision matrix at a second user portal logged onto a second user device, the decision matrix comprising:
the first set of cells exhibiting the first set of scores, the alternative score, and the third composite score; and
the second set of cells exhibiting the second set of scores and the second composite score.

12. The method of claim 1:
further comprising accessing a first context file representing information related to the first set of options;
wherein generating the first script comprises generating the first script instructing the generative pre-trained transformer model to, based on the first context file:
for the first option, in the set of options:
generate a first set of confidence scores corresponding to the first set of scores and representing a degree of certainty of each score, in the first set of scores; and
for the second option, in the set of options;
generate a second set of confidence scores corresponding to the second set of scores and representing a degree of certainty of each score, in the second set of scores;
wherein receiving the response comprises, receiving the response specifying the first set of confidence scores and the second set of confidence scores from the generative pre-trained transformer model; and
wherein generating the decision matrix comprises generating the decision matrix comprising:
the first set of cells corresponding to the first set of combinations and exhibiting the first set of scores, the first composite score, and the first set of confidence scores; and
the second set of cells corresponding to the second set of combinations and exhibiting the second set of scores, the second composite score, and the second set of confidence scores.

13. The method of claim 11, further comprising:
accessing a confidence score threshold associated with the first set of factors;
in response to a first confidence score, in the first set of confidence scores, falling below the confidence score threshold:
flagging a first combination, in the first set of combinations, associated with the first confidence score and a first score, in the first set of scores; and
generating a notification requesting additional context from the user related to the first combination of the pending decision;
serving the notification to the first user device;
receiving a second context file representing a text description of the first combination;
generating a second script instructing the generative pre-trained transformer model to, based on the first prompt and the second context file:
generate a second score associated with the first combination; and
generate a second confidence score associated with the second score;
serving the second script to the generative pre-trained transformer model for execution;
receiving a second response, from the generative pre-trained transformer model, specifying the second score and the second confidence score; and
updating a first cell, in the first set of cells, corresponding to the first combination in the decision matrix to exhibit the second score and the second confidence score, in place of the first score and the first confidence score.

14. The method of claim 1:
further comprising,
at a first time, accessing a first set of search results based on the first prompt; and
generating a first context file corresponding to the pending decision based on the first set of search results at the first time;
wherein generating the first script comprises generating the first script instructing the generative pre-trained transformer model to, based on the first prompt and the context file:
generate the first set of scores corresponding to the first set of combinations and representing suitability of the first option according to the first set of factors; and
generate the second set of scores corresponding to the second set of combinations and representing suitability of the second option according to the first set of factors; and
in response to absence of confirmation of a first option, in the first set of options, at the first user device, assigning a second time, following the first time, for revision of the decision matrix to a user profile logged on the first user device.

15. The method of claim 14, further comprising:
at the second time, accessing a second set of search results based on the first prompt;
generating a second context file distinct from the first context file corresponding to the pending decision based on the second set of search results at the second time;
generating a second script instructing the generative pre-trained transformer model to, based on the first prompt and the second context file:
generate a third set of scores corresponding to the first set of combinations and representing suitability of the first option according to the first set of factors; and
generate a fourth set of scores corresponding to the second set of combinations and representing suitability of the second option according to the first set of factors;
calculating a second set of composite scores comprising:
a third composite score of the first option based on the third set of scores; and
a fourth composite score of the second option based on the fourth set of scores and
updating the decision matrix to:
insert the third set of scores and the third composite score, in place of the first set of scores and the first composite score, in the first set of cells corresponding to the first set of combinations; and
insert the fourth set of scores and a fourth composite score, in place of the second set of scores and the second composite score, in the second set of cells corresponding to the second set of combinations.

16. A method for an automated decision-making workflow comprising:
receiving a first prompt associated with a pending decision;
identifying a set of options representing candidates for the pending decision;
identifying a set of factors representing criteria for the pending decision and attributes of the set of options;
at a first time, prior to rendering a first instance of a decision matrix:
accessing a first set of search results based on the first prompt;
generating a first context file of the set of options based on the first set of search results;
serving a first script to a generative model to:
access a set of combinations of options and factors based on the set of options and the set of factors; and
based on the first context file and the first prompt, generate a score, in a first set of scores, for each combination in the set of combinations of options and factors;
calculating a first set of composite scores for each option, in the set of options, based on subsets of scores, in the first set of scores; and
generating the decision matrix comprising cells exhibiting the first set of scores and the first set of composite scores of the set of combinations of options and factors;
rendering the first instance of the decision matrix;
at a second time, following the first time and prior to rendering a second instance of the decision matrix:
accessing a second set of search results based on the first prompt;
generating a second context file based on hypertext markup language data from the second set of search results;
serving a second script to a generative model to:
based on the second context file and the first prompt, generate a score, in a second set of scores, for each combination in the set of combinations of options and factors;
calculating a second set of composite scores for each option, in the set of options, based on subsets of scores, in the second set of scores; and
updating the decision matrix to insert the second set of scores and the second set of composite scores, in place of the first set of scores and the first composite score, within the cells of the decision matrix; and
rendering the second instance of the decision matrix.

17. The method of claim 16:
wherein rendering the interface comprises rendering the first instance of the interface comprising a set of sliders corresponding to the first set of factors, each slider, in the set of sliders, representing a weight of each factor, in the first set of factors; and
further comprising:
receiving a first input to a first slider, in the set of sliders, modifying a first weight value of a first factor, in the first set of factors, from a first baseline value;
accessing positions of weight values from the set of sliders following receipt of the first input;
calculating a third set of composite scores for each option, in the set of options, based on subsets of scores, in the second set of scores, and the positions of weight values from the set of sliders; and
updating cells in the decision matrix to exhibit the second set of scores and the third set of composite scores.

18. The method of claim 16, wherein identifying the set of factors comprises:
detecting a set of language signals in the first prompt, the set of language signals representing a decision domain of the pending decision;
receiving a second prompt specifying a first factor and a second factor associated with the pending decision;
generating a query to retrieve an initial set of factors based on the decision domain, the first factor, and the second factor;
identifying the initial set of factors based on the query;
generating a notification requesting a user to confirm factors in the initial set of factors;
serving the notification and the initial set of factors to a first user device;
receiving confirmation of a subset of factors, in the initial set of factors, at the first user device; and
in response to receiving confirmation of the subset of factors, identifying the subset of factors as the first set of factors.

19. A method for an automated decision-making workflow comprising:
receiving a first prompt associated with a pending decision;
identifying a set of options representing candidates for the pending decision;
identifying a set of factors representing criteria for the pending decision and attributes of the set of options;
generating a first script instructing a generative pre-trained transformer model to:
access a set of combinations of options and factors based on the set of options and the set of factors; and
generate a score, in a set of scores, for each combination in the set of combinations of options and factors, the score representing suitability of the combination;
serving the first script to the generative pre-trained transformer model for execution;
receiving, from the generative pre-trained transformer model, a response specifying the set of scores;
for each option, in the set of options:
calculating a composite score, in a set of composite scores, based on a subset of scores, in the set of scores, associated with the option;
generating a decision matrix comprising:
a first set of cells representing the set of combinations of options and factors, the first set of cells exhibiting the set of scores; and
a second set of cells exhibiting the set of composite scores for each option, in the set of options; and
rendering an interface depicting the decision matrix.

20. The method of claim 19:
further comprising:
accessing a first set of search results based on the first prompt;
extracting a first corpus of hypertext markup language data, representing information related to the first set of options, from the set of search results;
generating a second script instructing the generative pre-trained transformer model to summarize the first corpus of hypertext markup language data as a context file;
prior to serving the first script to the generative pre-trained transformer model, serving the second script to the generative pre-trained transformer model; and
receiving the context file from the generative pre-trained transformer model; and
wherein generating the first script comprises generating the first script instructing the generative pre-trained transformer model to, based on the first prompt and the context file:
generate the score, in the set of scores, for each combination in the set of combinations of options and factors.
